(19) United States
(12) Patent Application Publication
(10) Pub. No.: US 2006/0100368 A1
(43) Pub. Date: May 11, 2006

(54) Elastomer gum polymer systems

(76) Inventor: Edward Hosung Park, Saline, MI (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(21) Appl. No.: 10/983,926

(22) Filed: Nov. 8, 2004

(51) Int. Cl. C08F 8/00; C08L 77/00

(52) U.S. Cl. 525/50; 525/191; 525/178; 525/100

(57) ABSTRACT

Elastomer precursor gum (for any of fluoroelastomer, acrylic acid ester rubber/polyacrylate rubber, ethylene acrylic rubber, silicone, nitrile butyl rubber, hydrogenated nitrile rubber, natural rubber, polyurethane, and styrene butadiene rubber) and non-gum polymer are admixed with optional electrically conductive particulate and/or optional filler to provide either a continuous phase of polymer with dispersed gum portions, a continuous phase of elastomer precursor gum with dispersed polymer portions, or an interpenetrated structure of elastomer precursor gum and polymer. Curing is optionally enabled with techniques such as electron beam radiation.

This invention relates to polymer blends derived from elastomer gums.

Thermoplastic elastomers and thermoplastic vulcanizates (TPEs and TPVs) have a number of properties that make them the material of choice for applications where durability, strength, chemical resistance, and ease of processing are important. There are, however, ongoing challenges and problems that confront the manufacturer in using these materials.

One challenge relates to the degree and nature of intermixing of the elastomer (vulcanizate) into the thermoplastic and the subsequent impact of the nature of that intermixing on flow characteristics and processability. Product physical properties such as tensile modulus, tensile strength, elongation, compression set, and chemical resistance all have ranges that comparably reflect limitations in the blending or copolymerization of elastomers and thermoplastics. What is needed are polymer elastomer blends and a way of intermixing polymers and elastomers to provide extended flexibility in physical and mechanical properties beyond those currently available in existing TPEs and TPVs. This and other needs are addressed by the invention.

### SUMMARY

The invention is for composition of:
(a) a continuous phase of polymer; and
(b) a dispersed phase, the dispersed phase having a plurality of gum portions dispersed in the continuous phase, where each gum portion is dispersed from elastomer precursor gum having a glass transition temperature, a decomposition temperature, and, at a temperature having a value that is not less than the glass transition temperature and not greater than the decomposition temperature, a compressive set value from about 0 to about 5 percent of a mathematical difference between a non-vulcanized compressive set value for elastomer derived from the elastomer precursor gum and a fully-vulcanized compressive set value for the derived elastomer.

The invention is also for a composition of:
(a) a continuous phase of elastomer precursor gum having a glass transition temperature, a decomposition temperature, and, at a temperature having a value that is not less than the glass transition temperature and not greater than the decomposition temperature, a compressive set value from about 0 to about 5 percent of a mathematical difference between a non-vulcanized compressive set value for elastomer derived from the elastomer precursor gum and a fully-vulcanized compressive set value for the derived elastomer; and
(b) a dispersed phase of polymer, the dispersed phase comprising a plurality of polymer portions dispersed in the continuous phase.

The invention is also for a composition of:
(a) an interpenetrated structure of molecules of elastomer precursor gum molecules and molecules of a polymer, where the elastomer precursor gum molecules are intermixed into the interpenetrated structure from elastomer precursor gum having a compressive set value from about 0 to about 5 percent of a mathematical difference between a non-vulcanized compressive set value for an elastomer derived from the elastomer precursor gum and a fully-vulcanized compressive set value for the elastomer.

In one aspect, the elastomer precursor gum comprises precursor for an elastomer selected from the group consisting of fluoroelastomer, acrylic acid ester rubber/polyacrylate rubber, ethylene acrylic rubber, silicone, nitrile butyl rubber, hydrogenated nitrile rubber, natural rubber, polyurethane, styrene butadiene rubber, and combinations thereof.

In another aspect, the elastomer precursor gum has a Mooney viscosity of from about 0 to about 150 ML₁₊₁₀ at 121 degrees Celsius when the elastomer is fluoroelastomer, and the elastomer precursor gum has a Mooney viscosity of from about 0 to about 150 ML₁₊₄ at 100 degrees Celsius when the elastomer is any of acrylic acid ester rubber/polyacrylate rubber, ethylene acrylic rubber, silicone, nitrile butyl rubber, hydrogenated nitrile rubber, natural rubber, polyurethane, styrene butadiene rubber, and combinations thereof.

In one aspect, the polymer is any of acrylic acid ester rubber/polyacrylate rubber thermoplastic vulcanizate acrylonitrile-butadiene-styrene, amorphous nylon, cellulosic plastic, ethylene chlorotrifluoroethylene, epoxy resin, ethylene tetrafluoroethylene, ethylene acrylic rubber, ethylene acrylic rubber thermoplastic vulcanizate, ethylene acrylic monomer rubber/polyester thermoplastic elastomer, ethylene-propylene-diamine monomer rubber polypropylene thermoplastic vulcanizate, tetrafluoroethylene/hexafluoropropylene, fluoro-elastomer, fluoroelastomer thermoplastic vulcanizate, fluoroplastic, hydrogenated nitrile rubber, melamine-formaldehyde resin, tetrafluoroethylene/perfluoromethylvinyl ether, natural rubber, ethylene vinyl acetate, nitrile butyl rubber, nylon, nylon 6, nylon 610, nylon 612, nylon 63, nylon 64, nylon 66, perfluoroalkoxy (tetrafluoroethylene/perfluoromethylvinyl ether), phenolic resin, polyacetal, polyacrylate, polyamide, polyamide thermoset plastic, polyamide-imide, polybutene, polybutylene, polycarbonate, polyester, polyester thermoplastic, thermoplastic elastomer, polyesteretherketone, polyethylene, polyethylene terephthalate, polybutylene terephthalate, polyimide, polymethylmethacrylate, polyolefin, polyphenylene sulfide, polypropylene, polystyrene, polysulfone, polytetrafluoroethylene, polyurethane, polyurethane elastomer, polyvinyl chloride, polyvinylidene fluoride, ethylene propylene dimethyl/polypropylene thermoplastic vulcanizate, silicone, silicone-thermoplastic vulcanizate, silicone/polyacrylate, silcone/polyethylene terephthalate, thermoplastic polyurethane, thermoplastic polyurethane elastomer, thermoplastic polyurethane vulcanizate, polyurethane/polyamide thermoplastic elastomer, thermoplastic silicone vulcanizate, thermoplastic urethane, thermoplastic urethane elastomer, tetrafluoroethylene/hexafluoropropylene/vinylidene fluoride, polyamide-imide, and combinations thereof.

In one aspect, each of the dispersed portions has a cross-sectional diameter from about 0.1 microns to about 100 microns.

In another aspect, the dispersed phase comprises from about 20 weight percent to about 90 weight percent of the composition.

In one aspect, the compositions have electrically conductive particulate admixed in the composition admixture.

In one aspect, filler (fiberglass particulate, inorganic fiber particulate, carbon fiber particulate, ground rubber particulate, polytetrafluorinated ethylene particulate, microspheres, carbon nanotubes, or combinations thereof) is admixed in the composition admixture.

The invention is also for cured admixtures compositions of the above admixtures.

In a further aspect, the fluororelastomer is any of
(i) vinylidene fluoride/hexafluoropropylene copolymer fluoroelastomer having from about 66 weight percent to about 69 weight percent fluorine and a Mooney viscosity of from about 0 to about 130 ML₁₊₁₀ at 121 degrees Celsius,
(ii) vinylidene fluoride/perfluorovinyl ether/tetrafluoroethylene terpolymer fluoroelastomer having at least one cure site monomer and from about 64 weight percent to about 67 weight percent fluorine and a Mooney viscosity of from about 50 to about 100 ML₁₊₁₀ at 121 degrees Celsius,
(iii) tetrafluoroethylene/propylene/vinylidene fluoride terpolymer fluoro-elastomer having from about 59 weight percent to about 63 weight percent fluorine and a Mooney viscosity of from about 25 to about 45 ML₁₊₁₀ at 121 degrees Celsius,
(iv) tetrafluoroethylene/ethylene/perfluorovinyl ether terpolymer fluoro-elastomer having at least one cure site monomer and from about 60 weight percent to about 65 weight percent fluorine and a Mooney viscosity of from about 40 to about 80 ML₁₊₁₀ at 121 degrees Celsius,
(v) vinylidene fluoride/hexafluoropropylene/tetrafluoroethylene terpolymer fluoroelastomer having at least one cure site monomer and from about 66 weight percent to about 72.5 weight percent fluorine and a Mooney viscosity of from about 15 to about 90 ML₁₊₁₀ at 121 degrees Celsius,
vi) tetrafluoroethylene/propylene copolymer fluoroelastomer having about 57 weight percent fluorine and a Mooney viscosity of from about 25 to about 115 ML₁₊₁₀ at 121 degrees Celsius,
(vii) tetrafluoroethylene/ethylene/perfluorovinyl ether/vinylidene fluoride tetrapolymer fluoroelastomer having at least one cure site monomer and from about 59 weight percent to about 64 weight percent fluorine and a Mooney viscosity of from about 30 to about 70 ML₁₊₁₀ at 121 degrees Celsius,
(viii) tetrafluoroethylene/perfluorovinyl ether copolymer fluoroelastomer having at least one cure site monomer and from about 69 weight percent to about 71 weight percent fluorine and a Mooney viscosity of from about 60 to about 120 ML₁₊₁₀ at 121 degrees Celsius, fluoroelastomer corresponding to the formula
   [-TFE_{q}-HFPᵣ-VdFₛ-]_{d}
   and
(ix) combinations thereof,
where TFE is essentially a tetrafluoroethyl block, HFP is essentially a hexfluoropropyl block, and VdF is essentially a vinylidyl fluoride block, and products qd and rd and sd collectively provide proportions of TFE, HFP, and VdF whose values are within element 101 of FIG. 1.

The invention is also for admixing compositions according to the above formulations, curing such admixtures, forming the admixtures into useful articles, and/or forming the admixtures into precursor articles and then curing the precursor articles into useful articles.

In one aspect, coating of the particulate, prior to the admixing, is done to provide coated conductive particles as the conductive particulate, the conductive particles having a first surface tension between the conductive particles and the fluoropolymer, the coated conductive particles having a second surface tension between the coated conductive particles and the fluoropolymer, the second surface tension being less than the first surface tension.

In one aspect, curing comprises irradiating the admixture composition with any of ultraviolet radiation, infrared radiation, ionizing radiation, electron beam radiation, x-ray radiation, an irradiating plasma, a discharging corona, and a combination of these.

In another aspect, a curing agent is mixed into the admixture to cure the composition as follows:
(i) when the elastomer precursor gum is a precursor gum for fluoroelastomer, the curing agent is any of a bisphenol, a peroxide, and a combination thereof;
(ii) when the elastomer precursor gum is a precursor gum for acrylic acid ester rubber/polyacrylate rubber, the curing agent is any of a sulfur and surfactant blend, an amine, an epoxide, and a combination thereof;
(iii) when the elastomer precursor gum is a precursor gum for ethylene acrylic rubber, the curing agent is any of a peroxide, an amine, and a combination thereof;
(iv) when the elastomer precursor gum is a precursor gum for silicone, the curing agent is platinum;
(v) when the elastomer precursor gum is a precursor gum for nitrile butyl rubber, the curing agent is any of a peroxide, sulfur, and a combination thereof;
(vi) when the elastomer precursor gum is a precursor gum for hydrogenated nitrile rubber, the curing agent is any of a peroxide, sulfur, and a combination thereof;
(vii) when the elastomer precursor gum is a precursor gum for natural rubber, the curing agent is sulfur;
(viii) when the elastomer precursor gum is a precursor gum for polyurethane, the curing agent is any of a peroxide, a glycol, an amine, a multi-functional alcohol having a plurality of reduction groups for reducing isocyanatyl groups, and a combination thereof; and
(ix) when the elastomer precursor gum is a precursor gum for styrene butadiene rubber, the curing agent is any of sulfur, a peroxide, and a combination thereof.

In yet another aspect, admixing is achieved with any of batch polymer mixer, a roll mill, a continuous mixer, a single-screw mixing extruder, and a twin-screw extruder mixing extruder.

Further areas of applicability will become apparent from the detailed description provided hereinafter. It should be understood that the detailed description and specific examples, while indicating embodiments of the invention, are intended for purposes of illustration only and are not intended to limit the scope of the invention.

### BRIEF DESCRIPTION OF THE DRAWING

The present invention will become more fully understood from the detailed description and the accompanying drawing of FIG. 1.

FIG. 1 presents a ternary composition diagram for tetrafluoroethylene (TFE), hexfluoropropylene (HFP), and vinylidene fluoride blends.

It should be noted that the figure set forth herein is intended to exemplify the general characteristics of an apparatus, materials, and methods among those of this invention, for the purpose of the description of such embodiments herein. The figure may not precisely reflect the characteristics of any given embodiment, and is not necessarily intended to define or limit specific embodiments within the scope of this invention.

### DESCRIPTION

The following definitions and non-limiting guidelines must be considered in reviewing the description of this invention set forth herein.

The headings (such as “Introduction” and “Summary”) and sub-headings used herein are intended only for general organization of topics within the disclosure of the invention, and are not intended to limit the disclosure of the invention or any aspect thereof. In particular, subject matter disclosed in the “Introduction” may include aspects of technology within the scope of the invention, and may not constitute a recitation of prior art. Subject matter disclosed in the “Summary” is not an exhaustive or complete disclosure of the entire scope of the invention or any embodiments thereof.

The citation of references herein does not constitute an admission that those references are prior art or have any relevance to the patentability of the invention disclosed herein. All references cited in the Description section of this specification are hereby incorporated by reference in their entirety.

The description and specific examples, while indicating embodiments of the invention, are intended for purposes of illustration only and are not intended to limit the scope of the invention. Moreover, recitation of multiple embodiments having stated features is not intended to exclude other embodiments having additional features, or other embodiments incorporating different combinations the stated of features.

As used herein, the words “preferred” and “preferably” refer to embodiments of the invention that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the word “include,” and its variants, is intended to be non-limiting, such that recitation of items in a list is not to the exclusion of other like items that may also be useful in the materials, compositions, devices, and methods of this invention.

Most items of manufacture represent an intersection of considerations in both mechanical design and in materials design. In this regard, improvements in materials frequently are intertwined with improvements in mechanical design. The embodiments describe compounds, compositions, assemblies, and manufactured items that enable improvements in polymer material synthesis to be fully exploited.

The examples and other embodiments described herein are exemplary and not intended to be limiting in describing the full scope of compositions and methods of this invention. Equivalent changes, modifications and variations of specific embodiments, materials, compositions and methods may be made within the scope of the present invention, with substantially similar results.

The embodiments relate to polymer blends (admixtures) having one phase of elastomer gum and a second phase of either thermoplastic polymer or thermoset polymer. The following paragraphs clarify a number of terms and general concepts to further frame a basis for fully appreciating the embodiments.

Carbon-chain-based polymeric materials (polymers) are usefully defined as falling into one of three traditionally separate generic primary categories: thermoset materials (one type of plastic), thermoplastic materials (a second type of plastic), and elastomeric (or rubber-like) materials (elastomeric materials are not generally referenced as being “plastic” insofar as elastomers do not provide the property of a solid “finished” state). An important measurable consideration with respect to these three categories is the concept of a melting point—a point where a solid phase and a liquid phase of a material co-exist. In this regard, a thermoset material essentially cannot be melted after having been “set” or “cured” or “cross-linked”. Precursor component(s) to the thermoset plastic material are usually shaped in molten (or essentially liquid) form, but, once the setting process has executed, a melting point essentially does not exist for the material. A thermoplastic plastic material, in contrast, hardens into solid form (with attendant crystal generation), retains its melting point essentially indefinitely, and re-melts (albeit in some cases with a certain amount of degradation in general polymeric quality) after having been formed. An elastomeric (or rubber-like) material does not have a melting point; rather, the elastomer has a glass transition temperature where the polymeric material demonstrates an ability to usefully flow, but without co-existence of a solid phase and a liquid phase at a melting point.

Elastomers are frequently transformed into very robust flexible materials through the process of vulcanization. Depending upon the degree of vulcanization, the glass transition temperature may increase to a value that is too high for any practical attempt at liquefaction of the vulcanizate. Vulcanization implements inter-bonding between elastomer chains to provide an elastomeric material more robust against deformation than a material made from the elastomers in their pre-vulcanized state. In this regard, a measure of performance denoted as a “compression set value” is useful in measuring the degree of vulcanization (“curing”, “cross-linking”) in the elastomeric material. For the initial elastomer, when the material is in non-vulcanized elastomeric form, a non-vulcanized compression set value is measured according to ASTM D395 Method B and establishes thereby an initial compressive value for the particular elastomer. Under extended vulcanization, the elastomer vulcanizes to a point where its compression set value achieves an essentially constant maximum respective to further vulcanization, and, in so doing, thereby defines a material where a fully vulcanized compression set value for the particular elastomer is measurable. In applications, the elastomer is vulcanized to a compression set value useful for the application.

Augmenting the above-mentioned three general primary categories of thermoset plastic materials, thermoplastic plastic materials, and elastomeric materials are two blended combinations of thermoplastic and elastomers (vulcanizates) generally known as TPEs and TPVs. Thermoplastic elastomer (TPE) and thermoplastic vulcanizate (TPV) materials have been developed to partially combine the desired properties of thermoplastics with the desired properties of elastomers. As such, TPV materials are usually multi-phase admixtures of elastomer (vulcanizate) in thermoplastic. Traditionally, the elastomer (vulcanizate) phase and thermoplastic plastic phase co-exist in phase admixture after solidification of the thermoplastic phase; and the admixture is liquefied by heating the admixture above the melting point of the thermoplastic phase of the TPV. TPE materials are multi-phase mixtures, at the molecular level, of elastomer and thermoplastic and provide thereby block co-polymers of elastomer and thermoplastic. In this regard, TPEs are co-oligomeric block co-polymers derived from polymerization of at least one thermoplastic oligomer and at least one elastomeric oligomer. TPVs and TPEs both have melting points enabled by their respective thermoplastic phase(s).

The elastomeric phase in traditional TPV admixtures provides a compressive set value (as further discussed in the following paragraph) from about 50 to about 100 percent of a mathematical difference between a non-vulcanized compressive set value for the elastomer of the thermoplastic vulcanizate and a fully-vulcanized compressive set value for the elastomer. The elastomeric phase (elastomeric block sections in a thermoplastic elastomer) in traditional TPEs provides a compressive set value (as further discussed in the following paragraph) from about 80 to about 100 percent of a mathematical difference between a non-vulcanized compressive set value for the thermoplastic elastomer and a fully-vulcanized compressive set value for the thermoplastic elastomer.

With respect to a difference between a non-vulcanized compressive set value for an elastomer (thermoplastic elastomer) and a fully-vulcanized compressive set value for an elastomer (thermoplastic elastomer), it is to be noted that percentage in the 0 to about 100 percent range respective to a mathematical difference (between a non-vulcanized compression set value respective to a partially-vulcanized elastomer, thermoplastic elastomer, or elastomer gum and a fully-vulcanized compression set value respective to the elastomer, thermoplastic elastomer, or elastomer gum) applies to the degree of vulcanization in the elastomer, thermoplastic elastomer, or elastomer gum rather than to percentage recovery in a determination of a particular compression set value. As an example, an elastomer prior to vulcanization has a non-vulcanized compression set value of 72 (which could involve a 1000% recovery from a thickness measurement under compression to a thickness measurement after compression is released). After extended vulcanization, the vulcanized elastomer demonstrates a fully-vulcanized compression set value of 10. A mathematical difference between the values of 72 and 10 indicate a range of 62 between the non-vulcanized compression set value respective to the base elastomer and a fully-vulcanized compression set value respective to the base elastomer. Since the compression set value decreased with vulcanization in the example, a compressive set value within the range of 50 to about 100 percent of a mathematical difference between a non-vulcanized compression set value respective to the base elastomer and a fully-vulcanized compression set value respective to the base elastomer would therefore be achieved with a compressive set value between about 41 (50% between 72 and 10) and about 10 (the fully-vulcanized compression set value).

Returning now to specific considerations in the elastomeric polymeric phase of elastomer gum admixture material embodiments, a blend of elastomer precursor gum and either thermoplastic polymer, thermoset polymer, or thermoplastic elastomer provides a gum-enhanced admixture in a further set of alternative elastomer gum admixture material embodiments. In this regard, elastomer precursor gum is effectively a low molecular weight post-oligomer precursor for an elastomeric material. More specifically, elastomer gum has a glass transition temperature, a decomposition temperature, and, at a temperature having a value that is not less than the glass transition temperature and not greater than the decomposition temperature, a compressive set value (as further described herein) from about 0 to about 5 percent of a mathematical difference between a non-vulcanized compressive set value for elastomer derived from the elastomer precursor gum and a fully-vulcanized compressive set value for the derived elastomer. More specifically, the elastomer precursor gum has a Mooney viscosity of from about 0 to about 150 ML₁₊₁₀ at 121 degrees Celsius when the elastomer is fluoroelastomer, and the elastomer precursor gum has a Mooney viscosity of from about 0 to about 150 ML₁₊₄ at 100 degrees Celsius when the elastomer is any of acrylic acid ester rubber/polyacrylate rubber, ethylene acrylic rubber, silicone, nitrile butyl rubber, hydrogenated nitrile rubber, natural rubber, polyurethane, styrene butadiene rubber, and combinations thereof.

The thermoplastic polymer, thermoset polymer, or thermoplastic elastomer in the polymeric phase of elastomer gum admixture material embodiments is any of acrylic acid ester rubber/polyacrylate rubber thermoplastic vulcanizate acrylonitrile-butadiene-styrene, amorphous nylon, cellulosic plastic, ethylene chlorotrifluoroethylene, epoxy resin, ethylene tetrafluoroethylene, ethylene acrylic rubber, ethylene acrylic rubber thermoplastic vulcanizate, ethylene acrylic monomer rubber/polyester thermoplastic elastomer, ethylene-propylene-diamine monomer rubber/polypropylene thermoplastic vulcanizate, tetrafluoroethylene/hexa-fluoropropylene, fluoroelastomer, fluoroelastomer thermoplastic vulcanizate, fluoroplastic, hydrogenated nitrile rubber, melamine-formaldehyde resin, tetrafluoroethylene/perfluoro-methylvinyl ether, natural rubber, ethylene vinyl acetate, nitrile butyl rubber, nylon, nylon 6, nylon 610, nylon 612, nylon 63, nylon 64, nylon 66, perfluoroalkoxy (tetrafluoro-ethylene/perfluoromethylvinyl ether), phenolic resin, polyacetal, polyacrylate, polyamide, polyamide thermoset plastic, polyamide-imide, polybutene, polybutylene, polycarbonate, polyester, polyester thermoplastic, thermoplastic elastomer, polyesteretherketone, polyethylene, polyethylene terephthalate, polybutylene terephthalate, polyimide, polymethyl-methacrylate, polyolefin, polyphenylene sulfide, polypropylene, polystyrene, polysulfone, polytetrafluoroethylene, polyurethane, polyurethane elastomer, polyvinyl chloride, poly-vinylidene fluoride, ethylene propylene dimethyl/polypropylene thermoplastic vulcanizate, silicone, silicone-thermoplastic vulcanizate, silicone/polyacrylate, silcone/polyethylene terephthalate, thermoplastic polyurethane, thermoplastic polyurethane elastomer, thermoplastic polyurethane vulcanizate, polyurethane/polyamide thermoplastic elastomer, thermoplastic silicone vulcanizate, thermoplastic urethane, thermoplastic urethane elastomer, tetrafluoro-ethylene/hexafluoropropylene/vinylidene fluoride, polyamide-imide, and combinations thereof.

A gum-enhanced polymeric admixture in a continuous polymeric phase in an elastomer gum admixture material embodiment alternatively is an interpenetrated structure of polymer from the above thermoplastic polymer, thermoset polymer, and thermoplastic elastomer set admixed with elastomer precursor gum; a continuous phase of polymer from he above thermoplastic polymer, thermoset polymer, and thermoplastic elastomer set admixed with a dispersed phase of elastomer precursor gum; or a dispersed phase of polymer from the above thermoplastic polymer, thermoset polymer, and thermoplastic elastomer set admixed into a continuous phase of elastomer precursor gum.

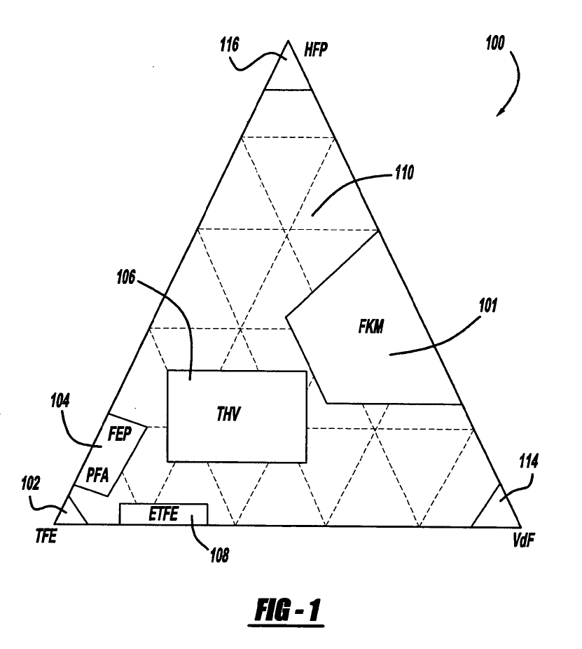

In the above embodiments fluororelastomer (either as a material or material of reference in either the thermoplastic polymer and thermoset polymer set or an elastomer ultimately derived from elastomer gum in the elastomer gum phase) is any of
(i) vinylidene fluoride/hexafluoropropylene copolymer fluoroelastomer having from about 66 weight percent to about 69 weight percent fluorine and a Mooney viscosity of from about 0 to about 130 ML₁₊₁₀ at 121 degrees Celsius,
(ii) vinylidene fluoride/perfluorovinyl ether/tetrafluoroethylene terpolymer fluoroelastomer having at least one cure site monomer and from about 64 weight percent to about 67 weight percent fluorine and a Mooney viscosity of from about 50 to about 100 ML₁₊₁₀ at 121 degrees Celsius,
(iii) tetrafluoroethylene/propylene/vinylidene fluoride terpolymer fluoroelastomer having from about 59 weight percent to about 63 weight percent fluorine and a Mooney viscosity of from about 25 to about 45 ML₁₊₁₀ at 121 degrees Celsius,
(iv) tetrafluoroethylene/ethylene/perfluorovinyl ether terpolymer fluoroelastomer having at least one cure site monomer and from about 60 weight percent to about 65 weight percent fluorine and a Mooney viscosity of from about 40 to about 80 ML₁₊₁₀ at 121 degrees Celsius,
(v) vinylidene fluoride/hexafluoropropylene/tetrafluoroethylene terpolymer fluoroelastomer having at least one cure site monomer and from about 66 weight percent to about 72.5 weight percent fluorine and a Mooney viscosity of from about 15 to about 90 ML₁₊₁₀ at 121 degrees Celsius,
(vi) tetrafluoroethylene/propylene copolymer fluoroelastomer having about 57 weight percent fluorine and a Mooney viscosity of from about 25 to about 115 ML₁₊₁₀ at 121 degrees Celsius,
(vii) tetrafluoroethylene/ethylene/perfluorovinyl ether/vinylidene fluoride tetra-polymer fluoroelastomer having at least one cure site monomer and from about 59 weight percent to about 64 weight percent fluorine and a Mooney viscosity of from about 30 to about 70 ML₁₊₁₀ at 121 degrees Celsius,
(viii) tetrafluoroethylene/perfluorovinyl ether copolymer fluoroelastomer having at least one cure site monomer and from about 69 weight percent to about 71 weight percent fluorine and a Mooney viscosity of from about 60 to about 120 ML₁₊₁₀ at 121 degrees Celsius, fluoroelastomer corresponding to the formula
   [-TFE_{q}-HFPᵣ-VdFₛ-]_{d}
   and
(ix) combinations thereof,
(x) where TFE is essentially a tetrafluoroethyl block, HFP is essentially a hexfluoropropyl block, and VdF is essentially a vinylidyl fluoride block, and products qd and rd and sd collectively provide proportions of TFE, HFP, and VdF whose values are within element 101 of FIG. 1 as described in the following paragraph.

Turning now to FIG. 1, a ternary composition diagram 100 is presented showing tetrafluoroethylene (TFE), hexfluoropropylene (HFP), and vinylidene fluoride weight percentage combinations for making various co-polymer blends. Region 101 defines blends of respective tetrafluoroethyl, hexfluoropropyl, and vinylidyl fluoride overall block amounts that combine to form fluoroelastomer (FKM) polymers. Region 104 defines blends of respective tetrafluoroethyl, hexfluoropropyl, and vinylidyl fluoride overall block amounts that combine to form perfluoroalkoxy tetrafluoroethylene/perfluoromethylvinyl ether and tetrafluoroethylene/hexafluoropropylene polymers. Region 106 defines blends of respective tetrafluoroethyl, hexfluoropropyl, and vinylidyl fluoride overall block amounts that combine to form tetrafluoroethylene/hexafluoropropylene/vinylidene fluoride polymers. Region 108 defines blends of respective tetrafluoroethyl, hexfluoropropyl, and vinylidyl fluoride overall block amounts that combine to form ethylene tetrafluoroethylene polymers. Region 110 defines blends of respective tetrafluoroethyl, hexfluoropropyl, and vinylidyl fluoride overall block amounts that traditionally have not generated useful co-polymers. Region 102 defines blends of respective tetrafluoroethyl, hexfluoropropyl, and vinylidyl fluoride overall block amounts that combine to form polytetrafluoroethtylene (PTFE) polymers. Region 114 defines blends of respective tetrafluoroethyl, hexfluoropropyl, and vinylidyl fluoride overall block amounts that combine to form polyvinylidene fluoride (PVdF) polymers. Region 116 defines blends of respective tetrafluoroethyl, hexfluoropropyl, and vinylidyl fluoride overall block amounts that combine to form polyhexfluoropropylene (PHFP) polymers.

A previously-described elastomer gum admixture is used in some embodiments as formulated. In alternative embodiments, a derived material is achieved by curing a previously described elastomer gum admixture to modify the elastomer gum phase into vulcanized elastomer. In some embodiments, the curing is achieved by admixing a curing agent into the elastomer gum admixture just prior to molding the elastomer gum admixture into a desired article. In this regard, a curing agent is admixed into the into the elastomer gum admixture preferably (without limitation) according to the following:
(i) when the elastomer precursor gum is a precursor gum for fluoroelastomer, the curing agent is any of a bisphenol, a peroxide, or a combination thereof;
(ii) when the elastomer precursor gum is a precursor gum for acrylic acid ester rubber/polyacrylate rubber, the curing agent is any of a sulfur and surfactant blend, an amine, an epoxide, or a combination thereof;
(iii) when the elastomer precursor gum is a precursor gum for ethylene acrylic rubber, the curing agent is any of a peroxide, an amine, or a combination thereof;
(iv) when the elastomer precursor gum is a precursor gum for silicone, the curing agent is platinum;
(v) when the elastomer precursor gum is a precursor gum for nitrile butyl rubber, the curing agent is any of a peroxide, sulfur, or a combination thereof;
(vi) when the elastomer precursor gum is a precursor gum for hydrogenated nitrile rubber, the curing agent is any of a peroxide, sulfur, or a combination thereof;
(vii) when the elastomer precursor gum is a precursor gum for natural rubber, the curing agent is sulfur;
(viii) when the elastomer precursor gum is a precursor gum for polyurethane, the curing agent is any of a peroxide, a glycol, an amine, a multi-functional alcohol having a plurality of reduction groups for reducing isocyanatyl groups, or a combination thereof; and
(ix) when the elastomer precursor gum is a precursor gum for styrene butadiene rubber, the curing agent is any of sulfur, a peroxide, or a combination thereof.

In an alternative embodiment, the elastomer gum admixture is cured with an energy source, such as electron beam radiation, to achieve a vulcanized elastomer from the elastomer gum.

In some embodiments, radiation curing effects another form of modification to the traditional three general primary categories of thermoset plastic materials, thermoplastic plastic materials, and elastomeric materials insofar as the radiation can generate cross-linked thermoplastic material, where a thermoplastic undergoes a certain degree of cross-linking via a treatment such as irradiation after having been solidified (to contain crystals of the thermoplastic polymer). In this regard, while the melting point of crystals in a cross-linked thermoplastic is sustained in all crystalline portions of the thermoplastic, the dynamic modulus of the cross-linked thermoplastic will be higher than that of the non-crosslinked thermoplastic due to crosslinkage between thermoplastic molecules in the amorphous phase of the thermoplastic. Further details in this regard are described in U.S. patent application Ser. No. 10/881,106 filed on Jun. 30, 2004 and entitled ELECTRON BEAM INTER-CURING OF PLASTIC AND ELASTOMER BLENDS incorporated by reference herein. In one such embodiment where the non-gum phase is thermoplastic polymer, the plastic moiety is derived from thermoplastic plastic; in a second embodiment where the non-gum phase is thermoset polymer, the plastic is derived from thermoset plastic.

When cured with radiation (preferably electron beam radiation), some elastomer gum admixture materials of this specification further generate inter-linking molecules at gum phase and (thermoplastic or thermoset) polymer phase interfaces. In this regard, a compound is formed: a molecule (usually a macromolecule) having one moiety (significant portion or significant sub-molecular part of a molecule) derived from the elastomer gum phase and a second moiety derived from the thermoplastic or thermoset polymer phase. Further details in very similar molecular constructs are appreciated from a study of U.S. patent application Ser. No. 10/881,106 filed on Jun. 30, 2004 and entitled ELECTRON BEAM INTER-CURING OF PLASTIC AND ELASTOMER BLENDS (previously referenced and incorporated by reference herein) and also U.S. patent application Ser. No. 10/881,677 filed on Jun. 30, 2004 and entitled ELECTRON BEAM CURING IN A COMPOSITE HAVING A FLOW RESISTANT ADHESIVE LAYER incorporated by reference herein.

Electron beam processing is usually effected with an electron accelerator. Individual accelerators are usefully characterized by their energy, power, and type. Low-energy accelerators provide beam energies from about 150 keV to about 2.0 MeV. Medium-energy accelerators provide beam energies from about 2.5 to about 8.0 MeV. High-energy accelerators provide beam energies greater than about 9.0 MeV. Accelerator power is a product of electron energy and beam current. Such powers range from about 5 to about 300 kW. The main types of accelerators are: electrostatic direct-current (DC), electrodynamic DC, radiofrequency (RF) linear accelerators (LINACS), magnetic-induction LINACs, and continuous-wave (CW) machines.

Thermoset plastic materials, thermoplastic plastic materials, elastomeric materials, thermoplastic elastomer materials, and thermoplastic vulcanizate materials generally are not considered to be electrically conductive. As such, electrical charge buildup on surfaces of articles made of these materials can occur to provide a “static charge” on a charged surface. When discharge of the charge buildup occurs to an electrically conductive material proximate to such a charged surface, an electrical spark manifests the essentially instantaneous current flowing between the charged surface to and the electrical conductor. Such a spark can be hazardous if the article is in service in applications or environments where flammable or explosive materials are present. Rapid discharge of static electricity can also damage some items (for example, without limitation, microelectronic articles) as critical electrical insulation is subjected to an instantaneous surge of electrical energy. Grounded articles made of materials having an electrical resistivity of less than about of 1×10 ⁻³ Ohm-m at 20 degrees Celsius are generally desired in such applications. Accordingly, in one embodiment, a dispersed phase of conductive particulate is provided in (admixed into) a previously-described elastomer gum admixture polymer phase to provide an electrically conductive polymeric material having an post-cured electrical resistivity of less than about of 1×10⁻³ Ohm-m at 20 degrees Celsius. This dispersed phase is made of a plurality of conductive particles dispersed in a continuous polymeric phase of elastomer gum admixture. In this regard, elastomer gum admixture is itself a multi-polymeric-phase polymer blend and/or admixture, so the dispersed phase of conductive particles is preferably dispersed throughout the various polymeric phases without specificity to any one of the polymeric phases in the multi-polymeric-phase elastomer gum admixture polymer phase.

The conductive particles used in alternative embodiments of electrically conductive polymeric materials include conductive carbon black, conductive carbon fiber, conductive carbon nanotubes, conductive graphite powder, conductive graphite fiber, bronze powder, bronze fiber, steel powder, steel fiber, iron powder, iron fiber, copper powder, copper fiber, silver powder, silver fiber, aluminum powder, aluminum fiber, nickel powder, nickel fiber, wolfram powder, wolfram fiber, gold powder, gold fiber, copper-manganese alloy powder, copper-manganese fiber, and combinations thereof.

In one embodiment, filler (particulate material contributing to the performance properties of the compounded elastomer gum admixture respective to such properties as, without limitation, bulk, weight, and/or viscosity while being essentially chemically inert or essentially reactively insignificant respective to chemical reactions within the compounded polymer) is also admixed into the formulation. The filler particulate is any material such as, without limitation, fiberglass particulate, inorganic fiber particulate, carbon fiber particulate, ground rubber particulate, or polytetrafluorinated ethylene particulate having a mean particle size from about 5 to about 50 microns; fiberglass, ceramic, or glass microspheres preferably having a mean particle size from about 5 to about 120 microns; or carbon nanotubes.

Turning now to a comprehensive discussion of methods for making elastomer gum admixtures, a polymeric admixture established by admixing differentiated phases of polymer usually differentiates the continuous phase and dispersed phase on the basis of relative viscosity between two initial polymeric fluids (where the first polymeric fluid has a first viscosity and the second polymeric fluid has a second viscosity). The phases are differentiated during admixing of the admixture from the two initial polymeric fluids. In this regard, the phase having the lower viscosity of the two phases will generally encapsulate the phase having the higher viscosity. The lower viscosity phase will therefore usually become the continuous phase in the admixture, and the higher viscosity phase will become the dispersed phase. When the viscosities are essentially equal, the two phases will form an interpenetrated structure of polymer chains. Accordingly, in general dependence upon the relative viscosities of the admixed elastomer and thermoplastic, several embodiments of admixed compositions derive from the general admixing approach and irradiation.

Preferably, each of the vulcanized, partially vulcanized, or gum elastomeric dispersed portions in a polymeric admixture has a cross-sectional diameter from about 0.1 microns to about 100 microns. In this regard, it is to be further appreciated that any portion is essentially spherical in shape in one embodiment, or, in an alternative embodiment, is filamentary in shape with the filament having a cross-sectional diameter from about 0.1 microns to about 100 microns. Comparably, when the vulcanized, partially vulcanized, or gum elastomeric portion is the continuous portion, the dispersed polymeric portion also has a cross-sectional diameter from about 0.1 microns to about 100 microns. The continuous phase of the polymeric admixture collectively is from about 20 weight percent to about 90 weight percent of the polymeric admixture composition.

Turning now to admixing method embodiments for making elastomer gum admixture embodiments discussed in the foregoing, one method embodiment for making a material compound embodiment is to admix the gum elastomer component and the thermoplastic polymer and/or thermoset polymer component(s) with a conventional mixing system such as a batch polymer mixer, a roll mill, a continuous mixer, a single-screw mixing extruder, a twin-screw extruder mixing extruder, and the like until the elastomer gum polymer system has been fully admixed. Specific commercial batch polymer mixer systems in this regard include any of a Moriyama mixer, a Banbury mixer, and a Brabender mixer. In another embodiment the elastomeric and thermoplastic components are intermixed at elevated temperature in the presence of an additive package in conventional mixing equipment as noted above. Conductive particulate and filler, if used, are then admixed into the continuous polymeric phase of the elastomer gum polymer system until fully dispersed in the continuous elastomer gum polymer system to yield electrically conductive elastomer gum polymeric material or filler-enhanced elastomer gum polymeric material. In one embodiment, the gum elastomer component and the thermoplastic polymer and/or thermoset polymer component(s) and the optional conductive (and optional filler) particulate are simultaneously admixed with a conventional mixing system such as a roll mill, continuous mixer, a single-screw mixing extruder, a twin-screw extruder mixing extruder, and the like until the conductive material has been fully admixed. In one embodiment, a curing agent is admixed into the gum polymer system shortly before use, and the gum polymer system is then formed into a useful article. In another embodiment, the gum polymer system is molded into an article precursor and the molded precursor is cured with radiation to yield the desired article.

A further advantageous characteristic of fully admixed compositions is that the admixture is readily processed and/or reprocessed by conventional plastic processing techniques such as extrusion, injection molding, and compression molding. Scrap or flashing is also readily salvaged and reprocessed with thermoplastic processing techniques.

In a preferred embodiment, a coating is applied to the optional conductive particles or filler, prior to the admixing, with a coating to provide coated conductive particles or coated filler as the conductive particulate or filler. In this regard, given that the uncoated particles have a (first) surface tension between the uncoated particles and the elastomer gum polymer, the coating is chosen so that the coated particles have a (second) surface tension between the coated particles and the elastomer gum polymer that is less than the first surface tension. The coating is applied to enable expedited admixing of the particulate into a fully dispersion within the continuous polymer phase of the elastomer gum polymer system. The coating is selected and the coated conductive particles are dispersed in sufficient quantity so that the desired electrical resistivity is achieved in the polymeric article if the conductive particulate is added to the elastomer gum system.

In a preferred embodiment, the irradiative curing is achieved by irradiating the elastomer molecule with electron beam radiation (preferably of from about 0.1 MeRAD to about 40 MeRAD and, more preferably, from about 5 MeRAD to about 20 MeRAD).

In one embodiment, the irradiative curing occurs within a cavity of a mold, where the housing of the mold enables transmission of an electron beam from an outside surface of the housing through the housing surface defining (at least in part) the cavity and thereby to the elastomer molecule. The penetration depth of a particular electron beam depends upon the strength of the electron beam, the density of the housing materials, and the particular material used in the housing. In one embodiment, cross-linking and/or curing of the molded precursor article is achieved by irradiating the dispersed and continuous phases within a cavity of the previously described mold, where the housing of the mold enables transmission of an electron beam from an outside surface of the housing through a surface of the cavity and thereby to the dispersed and continuous phases. In this regard, the entire mold housing is, in one embodiment, made of a material (such as glass, steel, plastic, brass, or aluminum) that will transmit the radiation (preferably an electron beam). In an alternative embodiment, a portion of the mold housing is made of a material that will transmit the radiation. In yet another embodiment, a beam port (glass, steel, plastic, brass, or aluminum) is embedded into the mold housing and the beam port is made of a material that will transmit the radiation.

The radiation used for curing can be ultraviolet radiation, infrared radiation, ionizing radiation, electron beam radiation, x-ray radiation, an irradiating plasma, a discharging corona, or a combination of these.

The benefits of irradiation have been shown to extend to flow characteristics, processability, surface and internal texturing. The curing process can be executed in situ in a mold by using an E-beam compatible (penetrable) mold of glass or thin metal or ceramic. Physical properties and chemical resistance of E-beam cured elastomers are adjustable respective to molecular weight and the degree of cross-linking density achieved with each irradiative treatment during the E-beam augmented curing process. The irradiative curing approach eliminates, in one embodiment, post cure curing processes and also enables elastomers to be molded and cured without the addition of expensive cure-site monomers (CSM) or chemical curing packages needed in traditional curing techniques.

In alternative embodiments, molding of elastomer gum polymer (or electrically conductive elastomer gum polymeric material) is achieved by various respective processes. Traditional processes such a calendaring, co-extrusion, multilayer extrusion, and co-injection molding are used in alternative process embodiments to achieve manufacture of the desired article.

Yet other applications (article embodiments) are for other packing sealant articles such as gaskets, dynamic seals, static seals, o-rings, co-extruded hose, and items having a sealant article such as a hose for handling chemicals or fuels where the inner layer of the hose has the chemical resistance properties of a PTFE “lining”. Other application (article) embodiments include encoders and co-extruded fuel hose (fuel line) where an inner liner cured from an electrically conductive fluoroelastomer gum admixture as described herein is grounded to dissipate any electrostatic charge buildup due to fuel passage through the fuel line. In making an embodiment of the fuel line, the electrically conductive fluoroelastomer gum admixture inner layer of the fuel is co-extruded with the structural material of the fuel hose and then the resulting fuel hose precursor is subsequently cured with an electron beam to provide the fuel hose.

The examples and other embodiments described herein are exemplary and not intended to be limiting in describing the full scope of compositions and methods of this invention. Equivalent changes, modifications and variations of specific embodiments, materials, compositions and methods may be made within the scope of the present invention, with substantially similar results.

What is claimed is:

1. A composition comprising:
(a) a continuous phase of polymer; and
(b) a dispersed phase, said dispersed phase comprising a plurality of gum portions dispersed in said continuous phase, wherein each said gum portion is dispersed from elastomer precursor gum having a glass transition temperature, a decomposition temperature, and, at a temperature having a value that is not less than said glass transition temperature and not greater than said decomposition temperature, a compressive set value from about 0 to about 5 percent of a mathematical difference between a non-vulcanized compressive set value for elastomer derived from said elastomer precursor gum and a fully-vulcanized compressive set value for said derived elastomer.

2. The composition of claim 1 wherein said elastomer precursor gum comprises precursor for an elastomer selected from the group consisting of fluoroelastomer, acrylic acid ester rubber/polyacrylate rubber, ethylene acrylic rubber, silicone, nitrile butyl rubber, hydrogenated nitrile rubber, natural rubber, polyurethane, styrene butadiene rubber, and combinations thereof.

3. The composition of claim 2 wherein said elastomer precursor gum has a Mooney viscosity of from about 0 to about 150 ML₁₊₁₀ at 121 degrees Celsius when said elastomer is fluoroelastomer, and said elastomer precursor gum has a Mooney viscosity of from about 0 to about 150 ML₁₊₄ at 100 degrees Celsius when said elastomer is selected from the group consisting of acrylic acid ester rubber/polyacrylate rubber, ethylene acrylic rubber, silicone, nitrile butyl rubber, hydrogenated nitrile rubber, natural rubber, polyurethane, styrene butadiene rubber, and combinations thereof.

4. The composition of claim 1 wherein said polymer is selected from the group consisting of acrylic acid ester rubber/polyacrylate rubber thermoplastic vulcanizate acrylonitrile-butadiene-styrene, amorphous nylon, cellulosic plastic, ethylene chlorotrifluoroethylene, epoxy resin, ethylene tetrafluoroethylene, ethylene acrylic rubber, ethylene acrylic rubber thermoplastic vulcanizate, ethylene acrylic monomer rubber/polyester thermoplastic elastomer, ethylene-propylene-diamine monomer rubber/polypropylene thermoplastic vulcanizate, tetrafluoroethylene/hexafluoropropylene, fluoroelastomer, fluoro-elastomer thermoplastic vulcanizate, fluoroplastic, hydrogenated nitrile rubber, melamine-formaldehyde resin, tetrafluoroethylene/perfluoromethylvinyl ether, natural rubber, ethylene vinyl acetate, nitrile butyl rubber, nylon, nylon 6, nylon 610, nylon 612, nylon 63, nylon 64, nylon 66, perfluoroalkoxy (tetrafluoroethylene/perfluoromethylvinyl ether), phenolic resin, polyacetal, polyacrylate, polyamide, polyamide thermoset plastic, polyamide-imide, polybutene, polybutylene, polycarbonate, polyester, polyester thermoplastic, thermoplastic elastomer, polyesteretherketone, polyethylene, polyethylene terephthalate, polybutylene terephthalate, polyimide, polymethylmethacrylate, polyolefin, polyphenylene sulfide, poly-propylene, polystyrene, polysulfone, polytetrafluoroethylene, polyurethane, polyurethane elastomer, polyvinyl chloride, polyvinylidene fluoride, ethylene propylene dimethyl/poly-propylene thermoplastic vulcanizate, silicone, silicone-thermoplastic vulcanizate, silicone/polyacrylate, silcone/polyethylene terephthalate, thermoplastic polyurethane, thermoplastic polyurethane elastomer, thermoplastic polyurethane vulcanizate, polyurethane/polyamide thermoplastic elastomer, thermoplastic silicone vulcanizate, thermoplastic urethane, thermoplastic urethane elastomer, tetrafluoroethylene/hexafluoropropylene/vinylidene fluoride, polyamide-imide, and combinations thereof.

5. The composition of claim 1 wherein said elastomer precursor gum comprises precursor for an elastomer selected from the group consisting of fluoroelastomer, acrylic acid ester rubber/polyacrylate rubber, ethylene acrylic rubber, silicone, nitrile butyl rubber, hydrogenated nitrile rubber, natural rubber, polyurethane, styrene butadiene rubber, and combinations thereof; and
said polymer is selected from the group consisting of acrylic acid ester rubber/polyacrylate rubber thermoplastic vulcanizate acrylonitrile-butadiene-styrene, amorphous nylon, cellulosic plastic, ethylene chlorotrifluoroethylene, epoxy resin, ethylene tetrafluoroethylene, ethylene acrylic rubber, ethylene acrylic rubber thermoplastic vulcanizate, ethylene acrylic monomer rubber/polyester thermoplastic elastomer, ethylene-propylene-diamine monomer rubber/polypropylene thermoplastic vulcanizate, tetrafluoro-ethylene/hexafluoropropylene, fluoroelastomer, fluoroelastomer thermoplastic vulcanizate, fluoroplastic, hydrogenated nitrile rubber, melamine-formaldehyde resin, tetrafluoro-ethylene/perfluoromethylvinyl ether, natural rubber, ethylene vinyl acetate, nitrile butyl rubber, nylon, nylon 6, nylon 610, nylon 612, nylon 63, nylon 64, nylon 66, perfluoroalkoxy (tetrafluoroethylene/perfluoromethylvinyl ether), phenolic resin, polyacetal, polyacrylate, polyamide, polyamide thermoset plastic, polyamide-imide, polybutene, polybutylene, polycarbonate, polyester, polyester thermoplastic, thermoplastic elastomer, poly-esteretherketone, polyethylene, polyethylene terephthalate, polybutylene terephthalate, polyimide, polymethylmethacrylate, polyolefin, polyphenylene sulfide, polypropylene, polystyrene, polysulfone, polytetrafluoroethylene, polyurethane, polyurethane elastomer, polyvinyl chloride, polyvinylidene fluoride, ethylene propylene dimethyl/polypropylene thermoplastic vulcanizate, silicone, silicone-thermoplastic vulcanizate, silicone/polyacrylate, silcone/polyethylene terephthalate, thermoplastic polyurethane, thermoplastic polyurethane elastomer, thermoplastic polyurethane vulcanizate, polyurethane/polyamide thermoplastic elastomer, thermoplastic silicone vulcanizate, thermoplastic urethane, thermoplastic urethane elastomer, tetrafluoroethylene/hexafluoropropylene/vinylidene fluoride, polyamide-imide, and combinations thereof.

6. The composition of claim 1 wherein each of said gum portions has a cross-sectional diameter from about 0.1 microns to about 100 microns.

7. The composition of claim 1 wherein said dispersed phase comprises from about 20 weight percent to about 90 weight percent of said composition.

8. The composition of claim 1 further comprising electrically conductive particulate admixed in said dispersed phase and in said continuous phase.

9. The composition of claim 1 further comprising filler selected from the group consisting of fiberglass particulate, inorganic fiber particulate, carbon fiber particulate, ground rubber particulate, polytetrafluorinated ethylene particulate, microspheres, carbon nanotubes, and combinations thereof.

10. A composition comprising:
(a) a continuous phase of elastomer precursor gum having a glass transition temperature, a decomposition temperature, and, at a temperature having a value that is not less than said glass transition temperature and not greater than said decomposition temperature, a compressive set value from about 0 to about 5 percent of a mathematical difference between a non-vulcanized compressive set value for elastomer derived from said elastomer precursor gum and a fully-vulcanized compressive set value for said derived elastomer; and
(b) a dispersed phase of polymer, said dispersed phase comprising a plurality of polymer portions dispersed in said continuous phase.

11. The composition of claim 10 wherein said elastomer precursor gum comprises precursor for an elastomer selected from the group consisting of fluoroelastomer, acrylic acid ester rubber/polyacrylate rubber, ethylene acrylic rubber, silicone, nitrile butyl rubber, hydrogenated nitrile rubber, natural rubber, polyurethane, styrene butadiene rubber, and combinations thereof.

12. The composition of claim 11 wherein said elastomer precursor gum has a Mooney viscosity of from about 0 to about 150 ML₁₊₁₀ at 121 degrees Celsius when said elastomer is fluoroelastomer, and said elastomer precursor gum has a Mooney viscosity of from about 0 to about 150 ML₁₊₄ at 100 degrees Celsius when said elastomer is selected from the group consisting of acrylic acid ester rubber/polyacrylate rubber, ethylene acrylic rubber, silicone, nitrile butyl rubber, hydrogenated nitrile rubber, natural rubber, polyurethane, styrene butadiene rubber, and combinations thereof.

13. The composition of claim 10 wherein said polymer is selected from the group consisting of acrylic acid ester rubber/polyacrylate rubber thermoplastic vulcanizate acrylonitrile-butadiene-styrene, amorphous nylon, cellulosic plastic, ethylene chlorotrifluoro-ethylene, epoxy resin, ethylene tetrafluoroethylene, ethylene acrylic rubber, ethylene acrylic rubber thermoplastic vulcanizate, ethylene acrylic monomer rubber/polyester thermoplastic elastomer, ethylene-propylene-diamine monomer rubber/polypropylene thermoplastic vulcanizate, tetrafluoroethylene/hexafluoropropylene, fluoroelastomer, fluoroelastomer thermoplastic vulcanizate, fluoroplastic, hydrogenated nitrile rubber, melamine-formaldehyde resin, tetrafluoroethylene/perfluoromethylvinyl ether, natural rubber, ethylene vinyl acetate, nitrile butyl rubber, nylon, nylon 6, nylon 610, nylon 612, nylon 63, nylon 64, nylon 66, perfluoroalkoxy (tetrafluoroethylene/perfluoromethylvinyl ether), phenolic resin, polyacetal, polyacrylate, polyamide, polyamide thermoset plastic, polyamide-imide, polybutene, polybutylene, polycarbonate, polyester, polyester thermoplastic, thermoplastic elastomer, polyesteretherketone, polyethylene, polyethylene terephthalate, polybutylene terephthalate, polyimide, polymethylmethacrylate, polyolefin, polyphenylene sulfide, polypropylene, polystyrene, polysulfone, polytetrafluoroethylene, polyurethane, polyurethane elastomer, polyvinyl chloride, polyvinylidene fluoride, ethylene propylene dimethyl/polypropylene thermoplastic vulcanizate, silicone, silicone-thermoplastic vulcanizate, silicone/polyacrylate, silcone/polyethylene terephthalate, thermoplastic polyurethane, thermoplastic polyurethane elastomer, thermoplastic polyurethane vulcanizate, polyurethane/polyamide thermoplastic elastomer, thermoplastic silicone vulcanizate, thermoplastic urethane, thermoplastic urethane elastomer, tetrafluoroethylene/hexafluoropropylene/vinylidene fluoride, polyamide-imide, and combinations thereof.

14. The composition of claim 10 wherein said wherein said elastomer precursor gum comprises precursor for an elastomer selected from the group consisting of fluoroelastomer, acrylic acid ester rubber/polyacrylate rubber, ethylene acrylic rubber, silicone, nitrile butyl rubber, hydrogenated nitrile rubber, natural rubber, polyurethane, styrene butadiene rubber, and combinations thereof; and
said polymer is selected from the group consisting of acrylic acid ester rubber/polyacrylate rubber thermoplastic vulcanizate acrylonitrile-butadiene-styrene, amorphous nylon, cellulosic plastic, ethylene chlorotrifluoroethylene, epoxy resin, ethylene tetrafluoroethylene, ethylene acrylic rubber, ethylene acrylic rubber thermoplastic vulcanizate, ethylene acrylic monomer rubber/polyester thermoplastic elastomer, ethylene-propylene-diamine monomer rubber/polypropylene thermoplastic vulcanizate, tetrafluoro-ethylene/hexafluoropropylene, fluoroelastomer, fluoroelastomer thermoplastic vulcanizate, fluoroplastic, hydrogenated nitrile rubber, melamine-formaldehyde resin, tetrafluoro-ethylene/perfluoromethylvinyl ether, natural rubber, ethylene vinyl acetate, nitrile butyl rubber, nylon, nylon 6, nylon 610, nylon 612, nylon 63, nylon 64, nylon 66, perfluoroalkoxy (tetrafluoroethylene/perfluoromethylvinyl ether), phenolic resin, polyacetal, polyacrylate, polyamide, polyamide thermoset plastic, polyamide-imide, polybutene, polybutylene, polycarbonate, polyester, polyester thermoplastic, thermoplastic elastomer, poly-esteretherketone, polyethylene, polyethylene terephthalate, polybutylene terephthalate, polyimide, polymethylmethacrylate, polyolefin, polyphenylene sulfide, polypropylene, polystyrene, polysulfone, polytetrafluoroethylene, polyurethane, polyurethane elastomer, polyvinyl chloride, polyvinylidene fluoride, ethylene propylene dimethyl/polypropylene thermoplastic vulcanizate, silicone, silicone-thermoplastic vulcanizate, silicone/polyacrylate, silcone/polyethylene terephthalate, thermoplastic polyurethane, thermoplastic polyurethane elastomer, thermoplastic polyurethane vulcanizate, polyurethane/polyamide thermoplastic elastomer, thermoplastic silicone vulcanizate, thermoplastic urethane, thermoplastic urethane elastomer, tetrafluoroethylene/hexafluoropropylene/vinylidene fluoride, polyamide-imide, and combinations thereof.

15. The composition of claim 10 wherein each of said polymer portions has a cross-sectional diameter from about 0.1 microns to about 100 microns.

16. The composition of claim 10 wherein said dispersed phase comprises from about 20 weight percent to about 90 weight percent of said composition.

17. The composition of claim 10 further comprising electrically conductive particulate admixed in said dispersed phase and in said continuous phase.

18. The composition of claim 10 further comprising filler selected from the group consisting of fiberglass particulate, inorganic fiber particulate, carbon fiber particulate, ground rubber particulate, polytetrafluorinated ethylene particulate, microspheres, carbon nanotubes, and combinations thereof.

19. A composition, comprising:
an interpenetrated structure of molecules of elastomer precursor gum molecules and molecules of a polymer, wherein said elastomer precursor gum molecules are intermixed into said interpenetrated structure from elastomer precursor gum having a compressive set value from about 0 to about 5 percent of a mathematical difference between a non-vulcanized compressive set value for an elastomer derived from said elastomer precursor gum and a fully-vulcanized compressive set value for said elastomer.

20. The composition of claim 19 wherein said elastomer precursor gum comprises precursor for an elastomer selected from the group consisting of fluoroelastomer, acrylic acid ester rubber/polyacrylate rubber, ethylene acrylic rubber, silicone, nitrile butyl rubber, hydrogenated nitrile rubber, natural rubber, polyurethane, styrene butadiene rubber, and combinations thereof.

21. The composition of claim 20 wherein said elastomer precursor gum has a Mooney viscosity of from about 0 to about 150 ML₁₊₁₀ at 121 degrees Celsius when said elastomer is fluoroelastomer, and said elastomer precursor gum has a Mooney viscosity of from about 0 to about 150 ML₁₊₄ at 100 degrees Celsius when said elastomer is selected from the group consisting of acrylic acid ester rubber/polyacrylate rubber, ethylene acrylic rubber, silicone, nitrile butyl rubber, hydrogenated nitrile rubber, natural rubber, polyurethane, styrene butadiene rubber, and combinations thereof.

22. The composition of claim 19 wherein said polymer is selected from the group consisting of acrylic acid ester rubber/polyacrylate rubber thermoplastic vulcanizate acrylonitrile-butadiene-styrene, amorphous nylon, cellulosic plastic, ethylene chloro-trifluoroethylene, epoxy resin, ethylene tetrafluoroethylene, ethylene acrylic rubber, ethylene acrylic rubber thermoplastic vulcanizate, ethylene acrylic monomer rubber/polyester thermoplastic elastomer, ethylene-propylene-diamine monomer rubber/polypropylene thermoplastic vulcanizate, tetrafluoroethylene/hexafluoropropylene, fluoroelastomer, fluoro-elastomer thermoplastic vulcanizate, fluoroplastic, hydrogenated nitrile rubber, melamine-formaldehyde resin, tetrafluoroethylene/perfluoromethylvinyl ether, natural rubber, ethylene vinyl acetate, nitrile butyl rubber, nylon, nylon 6, nylon 610, nylon 612, nylon 63, nylon 64, nylon 66, perfluoroalkoxy (tetrafluoroethylene/perfluoromethylvinyl ether), phenolic resin, polyacetal, polyacrylate, polyamide, polyamide thermoset plastic, polyamide-imide, polybutene, polybutylene, polycarbonate, polyester, polyester thermoplastic, thermoplastic elastomer, polyesteretherketone, polyethylene, polyethylene terephthalate, polybutylene terephthalate, polyimide, polymethylmethacrylate, polyolefin, polyphenylene sulfide, polypropylene, polystyrene, polysulfone, polytetrafluoroethylene, polyurethane, polyurethane elastomer, polyvinyl chloride, polyvinylidene fluoride, ethylene propylene dimethyl/polypropylene thermoplastic vulcanizate, silicone, silicone-thermoplastic vulcanizate, silicone/polyacrylate, silcone/polyethylene terephthalate, thermoplastic polyurethane, thermoplastic polyurethane elastomer, thermoplastic polyurethane vulcanizate, polyurethane/polyamide thermoplastic elastomer, thermoplastic silicone vulcanizate, thermoplastic urethane, thermoplastic urethane elastomer, tetrafluoroethylene/hexafluoropropylene/vinylidene fluoride, polyamide-imide, and combinations thereof.

23. The composition of claim 19 wherein said elastomer precursor gum comprises precursor for an elastomer selected from the group consisting of fluoroelastomer, acrylic acid ester rubber/polyacrylate rubber, ethylene acrylic rubber, silicone, nitrile butyl rubber, hydrogenated nitrile rubber, natural rubber, polyurethane, styrene butadiene rubber, and combinations thereof; and
said polymer is selected from the group consisting of acrylic acid ester rubber/polyacrylate rubber thermoplastic vulcanizate acrylonitrile-butadiene-styrene, amorphous nylon, cellulosic plastic, ethylene chlorotrifluoroethylene, epoxy resin, ethylene tetrafluoroethylene, ethylene acrylic rubber, ethylene acrylic rubber thermoplastic vulcanizate, ethylene acrylic monomer rubber/polyester thermoplastic elastomer, ethylene-propylene-diamine monomer rubber/polypropylene thermoplastic vulcanizate, tetrafluoro-ethylene/hexafluoropropylene, fluoroelastomer, fluoroelastomer thermoplastic vulcanizate, fluoroplastic, hydrogenated nitrile rubber, melamine-formaldehyde resin, tetrafluoro-ethylene/perfluoromethylvinyl ether, natural rubber, ethylene vinyl acetate, nitrile butyl rubber, nylon, nylon 6, nylon 610, nylon 612, nylon 63, nylon 64, nylon 66, perfluoroalkoxy (tetrafluoroethylene/perfluoromethylvinyl ether), phenolic resin, polyacetal, polyacrylate, polyamide, polyamide thermoset plastic, polyamide-imide, polybutene, polybutylene, polycarbonate, polyester, polyester thermoplastic, thermoplastic elastomer, poly-esteretherketone, polyethylene, polyethylene terephthalate, polybutylene terephthalate, polyimide, polymethylmethacrylate, polyolefin, polyphenylene sulfide, polypropylene, polystyrene, polysulfone, polytetrafluoroethylene, polyurethane, polyurethane elastomer, polyvinyl chloride, polyvinylidene fluoride, ethylene propylene dimethyl/polypropylene thermoplastic vulcanizate, silicone, silicone-thermoplastic vulcanizate, silicone/polyacrylate, silcone/polyethylene terephthalate, thermoplastic polyurethane, thermoplastic polyurethane elastomer, thermoplastic polyurethane vulcanizate, polyurethane/polyamide thermoplastic elastomer, thermoplastic silicone vulcanizate, thermoplastic urethane, thermoplastic urethane elastomer, tetrafluoroethylene/hexafluoropropylene/vinylidene fluoride, polyamide-imide, and combinations thereof.

24. The composition of claim 19 wherein said elastomer precursor gum comprises from about 20 weight percent to about 90 weight percent of said composition.

25. The composition of claim 19 further comprising electrically conductive particulate admixed in said interpenetrated structure.

26. The composition of claim 19 further comprising filler selected from the group consisting of fiberglass particulate, inorganic fiber particulate, carbon fiber particulate, ground rubber particulate, polytetrafluorinated ethylene particulate, microspheres, carbon nanotubes, and combinations thereof.

27. A composition comprising:
(a) a continuous phase of polymer; and
(b) a dispersed phase of vulcanized elastomer, said dispersed phase comprising a plurality of vulcanized elastomer portions dispersed in said continuous phase, wherein each said vulcanized elastomer portion is cured from elastomer precursor gum having a glass transition temperature, a decomposition temperature, and, at a temperature having a value that is not less than said glass transition temperature and not greater than said decomposition temperature, a compressive set value from about 0 to about 5 percent of a mathematical difference between a non-vulcanized compressive set value for elastomer derived from said elastomer precursor gum and a fully-vulcanized compressive set value for said derived elastomer.

28. The composition of claim 27 wherein said elastomer precursor gum comprises precursor for an elastomer selected from the group consisting of fluoroelastomer, acrylic acid ester rubber/polyacrylate rubber, ethylene acrylic rubber, silicone, nitrile butyl rubber, hydrogenated nitrile rubber, natural rubber, polyurethane, styrene butadiene rubber, and combinations thereof.

29. The composition of claim 27 wherein said elastomer precursor gum has a Mooney viscosity of from about 0 to about 150 ML₁₊₁₀ at 121 degrees Celsius when said elastomer is fluoroelastomer, and said elastomer precursor gum has a Mooney viscosity of from about 0 to about 150 ML₁₊₄ at 100 degrees Celsius when said elastomer is selected from the group consisting of
acrylic acid ester rubber/polyacrylate rubber, ethylene acrylic rubber, silicone, nitrile butyl rubber, hydrogenated nitrile rubber, natural rubber, polyurethane, styrene butadiene rubber, and combinations thereof.

30. The composition of claim 27 wherein said polymer is selected from the group consisting of acrylic acid ester rubber/polyacrylate rubber thermoplastic vulcanizate acrylonitrile-butadiene-styrene, amorphous nylon, cellulosic plastic, ethylene chlorotrifluoroethylene, epoxy resin, ethylene tetrafluoroethylene, ethylene acrylic rubber, ethylene acrylic rubber thermoplastic vulcanizate, ethylene acrylic monomer rubber/polyester thermoplastic elastomer, ethylene-propylene-diamine monomer rubber/polypropylene thermoplastic vulcanizate, tetrafluoroethylene/hexafluoropropylene, fluoroelastomer, fluoro-elastomer thermoplastic vulcanizate, fluoroplastic, hydrogenated nitrile rubber, melamine-formaldehyde resin, tetrafluoroethylene/perfluoromethylvinyl ether, natural rubber, ethylene vinyl acetate, nitrile butyl rubber, nylon, nylon 6, nylon 610, nylon 612, nylon 63, nylon 64, nylon 66, perfluoroalkoxy (tetrafluoroethylene/perfluoromethylvinyl ether), phenolic resin, polyacetal, polyacrylate, polyamide, polyamide thermoset plastic, polyamide-imide, polybutene, polybutylene, polycarbonate, polyester, polyester thermoplastic, thermoplastic elastomer, polyesteretherketone, polyethylene, polyethylene terephthalate, polybutylene terephthalate, polyimide, polymethylmethacrylate, polyolefin, polyphenylene sulfide, polypropylene, polystyrene, polysulfone, polytetrafluoroethylene, polyurethane, polyurethane elastomer, polyvinyl chloride, polyvinylidene fluoride, ethylene propylene dimethyl/poly-propylene thermoplastic vulcanizate, silicone, silicone-thermoplastic vulcanizate, silicone/polyacrylate, silcone/polyethylene terephthalate, thermoplastic polyurethane, thermoplastic polyurethane elastomer, thermoplastic polyurethane vulcanizate, polyurethane/polyamide thermoplastic elastomer, thermoplastic silicone vulcanizate, thermoplastic urethane, thermo-plastic urethane elastomer, tetrafluoroethylene/hexafluoropropylene/vinylidene fluoride, poly-amide-imide, and combinations thereof.

31. The composition of claim 27 wherein said elastomer precursor gum comprises precursor for an elastomer selected from the group consisting of fluoroelastomer, acrylic acid ester rubber/polyacrylate rubber, ethylene acrylic rubber, silicone, nitrile butyl rubber, hydrogenated nitrile rubber, natural rubber, polyurethane, styrene butadiene rubber, and combinations thereof; and
said polymer is selected from the group consisting of acrylic acid ester rubber/polyacrylate rubber thermoplastic vulcanizate acrylonitrile-butadiene-styrene, amorphous nylon, cellulosic plastic, ethylene chlorotrifluoroethylene, epoxy resin, ethylene tetrafluoroethylene, ethylene acrylic rubber, ethylene acrylic rubber thermoplastic vulcanizate, ethylene acrylic monomer rubber/polyester thermoplastic elastomer, ethylene-propylene-diamine monomer rubber/polypropylene thermoplastic vulcanizate, tetrafluoro-ethylene/hexafluoropropylene, fluoroelastomer, fluoroelastomer thermoplastic vulcanizate, fluoroplastic, hydrogenated nitrile rubber, melamine-formaldehyde resin, tetrafluoro-ethylene/perfluoromethylvinyl ether, natural rubber, ethylene vinyl acetate, nitrile butyl rubber, nylon, nylon 6, nylon 610, nylon 612, nylon 63, nylon 64, nylon 66, perfluoroalkoxy (tetrafluoroethylene/perfluoromethylvinyl ether), phenolic resin, polyacetal, polyacrylate, polyamide, polyamide thermoset plastic, polyamide-imide, polybutene, polybutylene, polycarbonate, polyester, polyester thermoplastic, thermoplastic elastomer, poly-esteretherketone, polyethylene, polyethylene terephthalate, polybutylene terephthalate, polyimide, polymethylmethacrylate, polyolefin, polyphenylene sulfide, polypropylene, polystyrene, polysulfone, polytetrafluoroethylene, polyurethane, polyurethane elastomer, polyvinyl chloride, polyvinylidene fluoride, ethylene propylene dimethyl/polypropylene thermoplastic vulcanizate, silicone, silicone-thermoplastic vulcanizate, silicone/polyacrylate, silcone/polyethylene terephthalate, thermoplastic polyurethane, thermoplastic polyurethane elastomer, thermoplastic polyurethane vulcanizate, polyurethane/polyamide thermoplastic elastomer, thermoplastic silicone vulcanizate, thermoplastic urethane, thermoplastic urethane elastomer, tetrafluoroethylene/hexafluoropropylene/vinylidene fluoride, polyamide-imide, and combinations thereof.

32. The composition of claim 27 wherein each of said vulcanized elastomer portions has a cross-sectional diameter from about 0.1 microns to about 100 microns.

33. The composition of claim 27 wherein said dispersed phase comprises from about 20 weight percent to about 90 weight percent of said composition.

34. The composition of claim 27 further comprising electrically conductive particulate admixed in said dispersed phase and in said continuous phase.

35. The composition of claim 27 further comprising filler selected from the group consisting of fiberglass particulate, inorganic fiber particulate, carbon fiber particulate, ground rubber particulate, polytetrafluorinated ethylene particulate, microspheres, carbon nanotubes, and combinations thereof.

36. A composition comprising:
(a) a continuous phase of vulcanized elastomer cured from elastomer precursor gum having a glass transition temperature, a decomposition temperature, and, at a temperature having a value that is not less than said glass transition temperature and not greater than said decomposition temperature, a compressive set value from about 0 to about 5 percent of a mathematical difference between a non-vulcanized compressive set value for elastomer derived from said elastomer precursor gum and a fully-vulcanized compressive set value for said derived elastomer; and
(b) a dispersed phase of polymer, said dispersed phase comprising a plurality of polymer portions dispersed in said continuous phase.

37. The composition of claim 36 wherein said elastomer precursor gum comprises precursor for an elastomer selected from the group consisting of fluoroelastomer, acrylic acid ester rubber/polyacrylate rubber, ethylene acrylic rubber, silicone, nitrile butyl rubber, hydrogenated nitrile rubber, natural rubber, polyurethane, styrene butadiene rubber, and combinations thereof.

38. The composition of claim 36 wherein said elastomer precursor gum has a Mooney viscosity of from about 0 to about 150 ML₁₊₁₀ at 121 degrees Celsius when said elastomer is fluoroelastomer, and said elastomer precursor gum has a Mooney viscosity of from about 0 to about 150 ML₁₊₄ at 100 degrees Celsius when said elastomer is selected from the group consisting of
acrylic acid ester rubber/polyacrylate rubber, ethylene acrylic rubber, silicone, nitrile butyl rubber, hydrogenated nitrile rubber, natural rubber, polyurethane, styrene butadiene rubber, and combinations thereof.

39. The composition of claim 36 wherein said polymer is selected from the group consisting of acrylic acid ester rubber/polyacrylate rubber thermoplastic vulcanizate acrylonitrile-butadiene-styrene, amorphous nylon, cellulosic plastic, ethylene chlorotrifluoroethylene, epoxy resin, ethylene tetrafluoroethylene, ethylene acrylic rubber, ethylene acrylic rubber thermoplastic vulcanizate, ethylene acrylic monomer rubber/polyester thermoplastic elastomer, ethylene-propylene-diamine monomer rubber/polypropylene thermoplastic vulcanizate, tetrafluoroethylene/hexafluoropropylene, fluoroelastomer, fluoro-elastomer thermoplastic vulcanizate, fluoroplastic, hydrogenated nitrile rubber, melamine-formaldehyde resin, tetrafluoroethylene/perfluoromethylvinyl ether, natural rubber, ethylene vinyl acetate, nitrile butyl rubber, nylon, nylon 6, nylon 610, nylon 612, nylon 63, nylon 64, nylon 66, perfluoroalkoxy (tetrafluoroethylene/perfluoromethylvinyl ether), phenolic resin, polyacetal, polyacrylate, polyamide, polyamide thermoset plastic, polyamide-imide, polybutene, polybutylene, polycarbonate, polyester, polyester thermoplastic, thermoplastic elastomer, polyesteretherketone, polyethylene, polyethylene terephthalate, polybutylene terephthalate, polyimide, polymethylmethacrylate, polyolefin, polyphenylene sulfide, polypropylene, polystyrene, polysulfone, polytetrafluoroethylene, polyurethane, polyurethane elastomer, polyvinyl chloride, polyvinylidene fluoride, ethylene propylene dimethyl/poly-propylene thermoplastic vulcanizate, silicone, silicone-thermoplastic vulcanizate, silicone/polyacrylate, silcone/polyethylene terephthalate, thermoplastic polyurethane, thermoplastic polyurethane elastomer, thermoplastic polyurethane vulcanizate, polyurethane/polyamide thermoplastic elastomer, thermoplastic silicone vulcanizate, thermoplastic urethane, thermo-plastic urethane elastomer, tetrafluoroethylene/hexafluoropropylene/vinylidene fluoride, polyamide-imide, and combinations thereof.

40. The composition of claim 36 wherein said wherein said elastomer precursor gum comprises precursor for an elastomer selected from the group consisting of fluoroelastomer, acrylic acid ester rubber/polyacrylate rubber, ethylene acrylic rubber, silicone, nitrile butyl rubber, hydrogenated nitrile rubber, natural rubber, polyurethane, styrene butadiene rubber, and combinations thereof; and
said polymer is selected from the group consisting of acrylic acid ester rubber/polyacrylate rubber thermoplastic vulcanizate acrylonitrile-butadiene-styrene, amorphous nylon, cellulosic plastic, ethylene chlorotrifluoroethylene, epoxy resin, ethylene tetrafluoroethylene, ethylene acrylic rubber, ethylene acrylic rubber thermoplastic vulcanizate, ethylene acrylic monomer rubber/polyester thermoplastic elastomer, ethylene-propylene-diamine monomer rubber/polypropylene thermoplastic vulcanizate, tetrafluoro-ethylene/hexafluoropropylene, fluoroelastomer, fluoroelastomer thermoplastic vulcanizate, fluoroplastic, hydrogenated nitrile rubber, melamine-formaldehyde resin, tetrafluoro-ethylene/perfluoromethylvinyl ether, natural rubber, ethylene vinyl acetate, nitrile butyl rubber, nylon, nylon 6, nylon 610, nylon 612, nylon 63, nylon 64, nylon 66, perfluoroalkoxy (tetrafluoroethylene/perfluoromethylvinyl ether), phenolic resin, polyacetal, polyacrylate, polyamide, polyamide thermoset plastic, polyamide-imide, polybutene, polybutylene, polycarbonate, polyester, polyester thermoplastic, thermoplastic elastomer, poly-esteretherketone, polyethylene, polyethylene terephthalate, polybutylene terephthalate, polyimide, polymethylmethacrylate, polyolefin, polyphenylene sulfide, polypropylene, polystyrene, polysulfone, polytetrafluoroethylene, polyurethane, polyurethane elastomer, polyvinyl chloride, polyvinylidene fluoride, ethylene propylene dimethyl/polypropylene thermoplastic vulcanizate, silicone, silicone-thermoplastic vulcanizate, silicone/polyacrylate, silcone/polyethylene terephthalate, thermoplastic polyurethane, thermoplastic polyurethane elastomer, thermoplastic polyurethane vulcanizate, polyurethane/polyamide thermoplastic elastomer, thermoplastic silicone vulcanizate, thermoplastic urethane, thermoplastic urethane elastomer, tetrafluoroethylene/hexafluoropropylene/vinylidene fluoride, polyamide-imide, and combinations thereof.

41. The composition of claim 36 wherein each of said polymer portions has a cross-sectional diameter from about 0.1 microns to about 100 microns.

42. The composition of claim 36 wherein said dispersed phase comprises from about 20 weight percent to about 90 weight percent of said composition.

43. The composition of claim 36 further comprising electrically conductive particulate admixed in said dispersed phase and in said continuous phase.

44. The composition of claim 36 further comprising filler selected from the group consisting of fiberglass particulate, inorganic fiber particulate, carbon fiber particulate, ground rubber particulate, polytetrafluorinated ethylene particulate, microspheres, carbon nanotubes, and combinations thereof.

45. A composition, comprising:
an interpenetrated structure of molecules of vulcanized elastomer and molecules of a polymer, wherein said vulcanized elastomer is cured from elastomer precursor gum having a compressive set value from about 0 to about 5 percent of a mathematical difference between a non-vulcanized compressive set value for an elastomer derived from said elastomer precursor gum and a fully-vulcanized compressive set value for said elastomer.

46. The composition of claim 45 wherein said elastomer precursor gum comprises precursor for an elastomer selected from the group consisting of fluoroelastomer, acrylic acid ester rubber/polyacrylate rubber, ethylene acrylic rubber, silicone, nitrile butyl rubber, hydrogenated nitrile rubber, natural rubber, polyurethane, styrene butadiene rubber, and combinations thereof.

47. The composition of claim 45 wherein said elastomer precursor gum has a Mooney viscosity of from about 0 to about 150 ML₁₊₁₀ at 121 degrees Celsius when said elastomer is fluoroelastomer, and said elastomer precursor gum has a Mooney viscosity of from about 0 to about 150 ML₁₊₄ at 100 degrees Celsius when said elastomer is selected from the group consisting of acrylic acid ester rubber/polyacrylate rubber, ethylene acrylic rubber, silicone, nitrile butyl rubber, hydrogenated nitrile rubber, natural rubber, polyurethane, styrene butadiene rubber, and combinations thereof.

48. The composition of claim 45 wherein said polymer is selected from the group consisting of acrylic acid ester rubber/polyacrylate rubber thermoplastic vulcanizate acrylonitrile-butadiene-styrene, amorphous nylon, cellulosic plastic, ethylene chlorotrifluoro-ethylene, epoxy resin, ethylene tetrafluoroethylene, ethylene acrylic rubber, ethylene acrylic rubber thermoplastic vulcanizate, ethylene acrylic monomer rubber/polyester thermoplastic elastomer, ethylene-propylene-diamine monomer rubber/polypropylene thermoplastic vulcanizate, tetrafluoroethylene/hexafluoropropylene, fluoroelastomer, fluoroelastomer thermoplastic vulcanizate, fluoroplastic, hydrogenated nitrile rubber, melamine-formaldehyde resin, tetrafluoroethylene/perfluoromethylvinyl ether, natural rubber, ethylene vinyl acetate, nitrile butyl rubber, nylon, nylon 6, nylon 610, nylon 612, nylon 63, nylon 64, nylon 66, perfluoroalkoxy (tetrafluoroethylene/perfluoromethylvinyl ether), phenolic resin, polyacetal, polyacrylate, polyamide, polyamide thermoset plastic, polyamide-imide, polybutene, polybutylene, polycarbonate, polyester, polyester thermoplastic, thermoplastic elastomer, polyesteretherketone, polyethylene, polyethylene terephthalate, polybutylene terephthalate, polyimide, polymethylmethacrylate, polyolefin, polyphenylene sulfide, polypropylene, polystyrene, polysulfone, polytetrafluoroethylene, polyurethane, polyurethane elastomer, polyvinyl chloride, polyvinylidene fluoride, ethylene propylene dimethyl/polypropylene thermoplastic vulcanizate, silicone, silicone-thermoplastic vulcanizate, silicone/polyacrylate, silcone/polyethylene terephthalate, thermoplastic polyurethane, thermoplastic polyurethane elastomer, thermoplastic polyurethane vulcanizate, polyurethane/polyamide thermoplastic elastomer, thermoplastic silicone vulcanizate, thermoplastic urethane, thermoplastic urethane elastomer, tetrafluoroethylene/hexafluoropropylene/vinylidene fluoride, polyamide-imide, and combinations thereof.

49. The composition of claim 45 wherein said elastomer precursor gum comprises precursor for an elastomer selected from the group consisting of fluoroelastomer, acrylic acid ester rubber/polyacrylate rubber, ethylene acrylic rubber, silicone, nitrile butyl rubber, hydrogenated nitrile rubber, natural rubber, polyurethane, styrene butadiene rubber, and combinations thereof; and
said polymer is selected from the group consisting of acrylic acid ester rubber/polyacrylate rubber thermoplastic vulcanizate acrylonitrile-butadiene-styrene, amorphous nylon, cellulosic plastic, ethylene chlorotrifluoroethylene, epoxy resin, ethylene tetrafluoroethylene, ethylene acrylic rubber, ethylene acrylic rubber thermoplastic vulcanizate, ethylene acrylic monomer rubber/polyester thermoplastic elastomer, ethylene-propylene-diamine monomer rubber/polypropylene thermoplastic vulcanizate, tetrafluoro-ethylene/hexafluoropropylene, fluoroelastomer, fluoroelastomer thermoplastic vulcanizate, fluoroplastic, hydrogenated nitrile rubber, melamine-formaldehyde resin, tetrafluoro-ethylene/perfluoromethylvinyl ether, natural rubber, ethylene vinyl acetate, nitrile butyl rubber, nylon, nylon 6, nylon 610, nylon 612, nylon 63, nylon 64, nylon 66, perfluoroalkoxy (tetrafluoroethylene/perfluoromethylvinyl ether), phenolic resin, polyacetal, polyacrylate, polyamide, polyamide thermoset plastic, polyamide-imide, polybutene, polybutylene, polycarbonate, polyester, polyester thermoplastic, thermoplastic elastomer, polyester-etherketone, polyethylene, polyethylene terephthalate, polybutylene terephthalate, polyimide, polymethylmethacrylate, polyolefin, polyphenylene sulfide, polypropylene, polystyrene, polysulfone, polytetrafluoroethylene, polyurethane, polyurethane elastomer, polyvinyl chloride, polyvinylidene fluoride, ethylene propylene dimethyl/polypropylene thermoplastic vulcanizate, silicone, silicone-thermoplastic vulcanizate, silicone/polyacrylate, silcone/polyethylene terephthalate, thermoplastic polyurethane, thermoplastic polyurethane elastomer, thermoplastic polyurethane vulcanizate, polyurethane/polyamide thermoplastic elastomer, thermoplastic silicone vulcanizate, thermoplastic urethane, thermoplastic urethane elastomer, tetrafluoroethylene/hexafluoropropylene/vinylidene fluoride, polyamide-imide, and combinations thereof.

50. The composition of claim 45 wherein said elastomer precursor gum comprises from about 20 weight percent to about 90 weight percent of said composition.

51. The composition of claim 45 further comprising electrically conductive particulate admixed in said interpenetrated structure.

52. The composition of claim 45 further comprising filler selected from the group consisting of fiberglass particulate, inorganic fiber particulate, carbon fiber particulate, ground rubber particulate, polytetrafluorinated ethylene particulate, microspheres, carbon nanotubes, and combinations thereof.

53. The composition of any of claims 2, 3, 5, 11, 12, 14, 20, 21, 23, 28, 29, 31, 37, 38, 40, 46, 47, and 49 wherein said fluororelastomer is selected from the group consisting of
(i) vinylidene fluoride/hexafluoropropylene copolymer fluoroelastomer having from about 66 weight percent to about 69 weight percent fluorine and a Mooney viscosity of from about 0 to about 130 ML₁₊₁₀ at 121 degrees Celsius,
(ii) vinylidene fluoride/perfluorovinyl ether/tetrafluoroethylene terpolymer fluoroelastomer having at least one cure site monomer and from about 64 weight percent to about 67 weight percent fluorine and a Mooney viscosity of from about 50 to about 100 ML₁₊₁₀ at 121 degrees Celsius,
(iii) tetrafluoroethylene/propylene/vinylidene fluoride terpolymer fluoroelastomer having from about 59 weight percent to about 63 weight percent fluorine and a Mooney viscosity of from about 25 to about 45 ML₁₊₁₀ at 121 degrees Celsius,
(iv) tetrafluoroethylene/ethylene/perfluorovinyl ether terpolymer fluoroelastomer having at least one cure site monomer and from about 60 weight percent to about 65 weight percent fluorine and a Mooney viscosity of from about 40 to about 80 ML₁₊₁₀ at 121 degrees Celsius,
(v) vinylidene fluoride/hexafluoropropylene/tetrafluoroethylene terpolymer fluoroelastomer having at least one cure site monomer and from about 66 weight percent to about 72.5 weight percent fluorine and a Mooney viscosity of from about 15 to about 90 ML₁₊₁₀ at 121 degrees Celsius,
(vi) tetrafluoroethylene/propylene copolymer fluoroelastomer having about 57 weight percent fluorine and a Mooney viscosity of from about 25 to about 115 ML₁₊₁₀ at 121 degrees Celsius,
(vii) tetrafluoroethylene/ethylene/perfluorovinyl ether/vinylidene fluoride tetrapolymer fluoroelastomer having at least one cure site monomer and from about 59 weight percent to about 64 weight percent fluorine and a Mooney viscosity of from about 30 to about 70 ML₁₊₁₀ at 121 degrees Celsius,
(viii) tetrafluoroethylene/perfluorovinyl ether copolymer fluoroelastomer having at least one cure site monomer and from about 69 weight percent to about 71 weight percent fluorine and a Mooney viscosity of from about 60 to about 120 ML₁₊₁₀ at 121 degrees Celsius, fluoroelastomer corresponding to the formula
[-TFE_{q}-HFPᵣ-VdFₛ-]_{d}
and
(ix) combinations thereof,
wherein TFE is essentially a tetrafluoroethyl block, HFP is essentially a hexfluoropropyl block, and VdF is essentially a vinylidyl fluoride block, and products qd and rd and sd collectively provide proportions of TFE, HFP, and VdF whose values are within element 101 of FIG. 1.

54. A method for making an admixture composition, comprising:
(a) admixing
(i) a polymer; and
(ii) elastomer precursor gum having a glass transition temperature, a decomposition temperature, and, at a temperature having a value that is not less than said glass transition temperature and not greater than said decomposition temperature, a compressive set value from about 0 to about 5 percent of a mathematical difference between a non-vulcanized compressive set value for elastomer derived from said elastomer precursor gum and a fully-vulcanized compressive set value for said derived elastomer.

55. The method of claim 54 wherein, in said admixing, said elastomer precursor gum is a precursor for an elastomer selected from the group consisting of fluoroelastomer, acrylic acid ester rubber/polyacrylate rubber, ethylene acrylic rubber, silicone, nitrile butyl rubber, hydrogenated nitrile rubber, natural rubber, polyurethane, styrene butadiene rubber, and combinations thereof.

56. The method of claim 54 wherein, in said admixing, said elastomer precursor gum has a Mooney viscosity of from about 0 to about 150 ML₁₊₁₀ at 121 degrees Celsius when said elastomer is fluoroelastomer, and said elastomer precursor gum has a Mooney viscosity of from about 0 to about 150 ML₁₊₄ at 100 degrees Celsius when said elastomer is selected from the group consisting of
acrylic acid ester rubber/polyacrylate rubber, ethylene acrylic rubber, silicone, nitrile butyl rubber, hydrogenated nitrile rubber, natural rubber, polyurethane, styrene butadiene rubber, and combinations thereof.

57. The method of claim 54 wherein said admixing further comprises admixing
(iii) filler selected from the group consisting of fiberglass particulate, inorganic fiber particulate, carbon fiber particulate, ground rubber particulate, polytetrafluorinated ethylene particulate, microspheres, carbon nanotubes, and combinations thereof.

58. The method of any of claims and 55 and 56 wherein said fluororelastomer is selected from the group consisting of
(i) vinylidene fluoride/hexafluoropropylene copolymer fluoroelastomer having from about 66 weight percent to about 69 weight percent fluorine and a Mooney viscosity of from about 0 to about 130 ML₁₊₁₀ at 121 degrees Celsius,
(ii) vinylidene fluoride/perfluorovinyl ether/tetrafluoroethylene terpolymer fluoroelastomer having at least one cure site monomer and from about 64 weight percent to about 67 weight percent fluorine and a Mooney viscosity of from about 50 to about 100 ML₁₊₁₀ at 121 degrees Celsius,
(iii) tetrafluoroethylene/propylene/vinylidene fluoride terpolymer fluoroelastomer having from about 59 weight percent to about 63 weight percent fluorine and a Mooney viscosity of from about 25 to about 45 ML₁₊₁₀ at 121 degrees Celsius,
(iv) tetrafluoroethylene/ethylene/perfluorovinyl ether terpolymer fluoroelastomer having at least one cure site monomer and from about 60 weight percent to about 65 weight percent fluorine and a Mooney viscosity of from about 40 to about 80 ML₁₊₁₀ at 121 degrees Celsius,
(v) vinylidene fluoride/hexafluoropropylene/tetrafluoroethylene terpolymer fluoroelastomer having at least one cure site monomer and from about 66 weight percent to about 72.5 weight percent fluorine and a Mooney viscosity of from about 15 to about 90 ML₁₊₁₀ at 121 degrees Celsius,
(vi) tetrafluoroethylene/propylene copolymer fluoroelastomer having about 57 weight percent fluorine and a Mooney viscosity of from about 25 to about 115 ML₁₊₁₀ at 121 degrees Celsius,
(vii) tetrafluoroethylene/ethylene/perfluorovinyl ether/vinylidene fluoride tetrapolymer fluoroelastomer having at least one cure site monomer and from about 59 weight percent to about 64 weight percent fluorine and a Mooney viscosity of from about 30 to about 70 ML₁₊₁₀ at 121 degrees Celsius,
(viii) tetrafluoroethylene/perfluorovinyl ether copolymer fluoroelastomer having at least one cure site monomer and from about 69 weight percent to about 71 weight percent fluorine and a Mooney viscosity of from about 60 to about 120 ML₁₊₁₀ at 121 degrees Celsius, fluoroelastomer corresponding to the formula
[-TFE_{q}-HFPᵣ-VdFₛ-]_{d}
and
(ix) combinations thereof,
wherein TFE is essentially a tetrafluoroethyl block, HFP is essentially a hexfluoropropyl block, and VdF is essentially a vinylidyl fluoride block, and products qd and rd and sd collectively provide proportions of TFE, HFP, and VdF whose values are within element 101 of FIG. 1.

59. The method of claim 54 wherein, in said admixing, said polymer is selected from the group consisting of acrylic acid ester rubber/polyacrylate rubber thermoplastic vulcanizate acrylonitrile-butadiene-styrene, amorphous nylon, cellulosic plastic, ethylene chlorotrifluoroethylene, epoxy resin, ethylene tetrafluoroethylene, ethylene acrylic rubber, ethylene acrylic rubber thermoplastic vulcanizate, ethylene acrylic monomer rubber/polyester thermoplastic elastomer, ethylene-propylene-diamine monomer rubber/polypropylene thermoplastic vulcanizate, tetrafluoroethylene/hexafluoropropylene, fluoroelastomer, fluoroelastomer thermoplastic vulcanizate, fluoroplastic, hydrogenated nitrile rubber, melamine-formaldehyde resin, tetrafluoroethylene/perfluoromethylvinyl ether, natural rubber, ethylene vinyl acetate, nitrile butyl rubber, nylon, nylon 6, nylon 610, nylon 612, nylon 63, nylon 64, nylon 66, perfluoroalkoxy (tetrafluoroethylene/perfluoromethylvinyl ether), phenolic resin, polyacetal, polyacrylate, polyamide, polyamide thermoset plastic, polyamide-imide, polybutene, polybutylene, polycarbonate, polyester, polyester thermoplastic, thermoplastic elastomer, polyesteretherketone, polyethylene, polyethylene terephthalate, polybutylene terephthalate, polyimide, polymethylmethacrylate, polyolefin, polyphenylene sulfide, polypropylene, polystyrene, polysulfone, polytetrafluoroethylene, polyurethane, polyurethane elastomer, polyvinyl chloride, polyvinylidene fluoride, ethylene propylene dimethyl/polypropylene thermoplastic vulcanizate, silicone, silicone-thermoplastic vulcanizate, silicone/polyacrylate, silcone/polyethylene terephthalate, thermoplastic polyurethane, thermoplastic polyurethane elastomer, thermoplastic polyurethane vulcanizate, polyurethane/polyamide thermoplastic elastomer, thermoplastic silicone vulcanizate, thermoplastic urethane, thermoplastic urethane elastomer, tetrafluoroethylene/hexafluoropropylene/vinylidene fluoride, polyamide-imide, and combinations thereof.

60. The method of claim 54 wherein said admixing further comprises admixing
(iii) conductive particulate selected from the group consisting of conductive carbon black, conductive carbon fiber, conductive carbon nanotubes, conductive graphite powder, conductive graphite fiber, bronze powder, bronze fiber, steel powder, steel fiber, iron powder, iron fiber, copper powder, copper fiber, silver powder, silver fiber, aluminum powder, aluminum fiber, nickel powder, nickel fiber, wolfram powder, wolfram fiber, gold powder, gold fiber, copper-manganese alloy powder, copper-manganese fiber, and combinations thereof.

61. The method of claim 60 further comprising coating, prior to said admixing, conductive particles of said particulate with a coating to provide coated conductive particles as said conductive particulate, said conductive particles having a first surface tension between said conductive particles and said fluoropolymer, said coated conductive particles having a second surface tension between said coated conductive particles and said fluoropolymer, said second surface tension less than said first surface tension.

62. The method of claim 60 wherein said conductive particulate comprises conductive particles and essentially all of said conductive particles admixed in said admixing independently have a cross-sectional diameter from about 0.1 microns to about 100 microns.

63. The method of claim 54 wherein said admixing admixes a dispersed phase of said elastomer precursor gum into a continuous phase of said polymer.

64. The method of claim 54 wherein said admixing admixes a dispersed phase of said polymer into a continuous phase of said elastomer precursor gum.

65. The method of claim 54 wherein said admixing admixes said polymer and said elastomer precursor gum into an interpenetrated structure.

66. The method of claim 54 wherein said admixing admixes said polymer and said elastomer precursor gum into an admixture, said method further comprising
(b) curing said admixture.

67. The method of claim 66 wherein said curing comprises irradiating said admixture composition with radiation.

68. The method of claim 67 wherein said radiation is selected from the group consisting of ultraviolet radiation, infrared radiation, ionizing radiation, electron beam radiation, x-ray radiation, an irradiating plasma, a discharging corona, and a combination of these.

69. The method of claim 66 wherein said curing comprises admixing a curing agent into said admixture wherein
(i) when said elastomer precursor gum is a precursor gum for fluoroelastomer, said curing agent is selected from the group consisting of a bisphenol, a peroxide, and a combination thereof;
(ii) when said elastomer precursor gum is a precursor gum for acrylic acid ester rubber/polyacrylate rubber, said curing agent is selected from the group consisting of a sulfur and surfactant blend, an amine, an epoxide, and a combination thereof;
(iii) when said elastomer precursor gum is a precursor gum for ethylene acrylic rubber, said curing agent is selected from the group consisting of a peroxide, an amine, and a combination thereof;
(iv) when said elastomer precursor gum is a precursor gum for silicone, said curing agent is platinum;
(v) when said elastomer precursor gum is a precursor gum for nitrile butyl rubber, said curing agent is selected from the group consisting of a peroxide, sulfur, and a combination thereof;
(vi) when said elastomer precursor gum is a precursor gum for hydrogenated nitrile rubber, said curing agent is selected from the group consisting of a peroxide, sulfur, and a combination thereof;
(vii) when said elastomer precursor gum is a precursor gum for natural rubber, said curing agent is sulfur;
(viii) when said elastomer precursor gum is a precursor gum for polyurethane, said curing agent is selected from the group consisting of a peroxide, a glycol, an amine, a multi-functional alcohol having a plurality of reduction groups for reducing isocyanatyl groups, and a combination thereof; and
(ix) when said elastomer precursor gum is a precursor gum for styrene butadiene rubber, said curing agent is selected from the group consisting of sulfur, a peroxide, and a combination thereof.

70. The method of claim 54 wherein said admixing admixes said polymer and said elastomer precursor gum into an admixture, said method further comprising
(b) forming said admixture into a precursor article of an article; and
(c) curing said precursor article to provide said admixture composition as a formed composition.

71. The method of claim 70 wherein said curing comprises irradiating said precursor article with radiation.

72. The method of claim 71 wherein said radiation is selected from the group consisting of ultraviolet radiation, infrared radiation, ionizing radiation, electron beam radiation, x-ray radiation, an irradiating plasma, a discharging corona, and a combination of these.

73. The method of claim 70 wherein said curing comprises admixing, prior to said forming, a curing agent into said admixture wherein
(i) when said elastomer precursor gum is a precursor gum for fluoroelastomer, said curing agent is selected from the group consisting of a bisphenol, a peroxide, and a combination thereof;
(ii) when said elastomer precursor gum is a precursor gum for acrylic acid ester rubber/polyacrylate rubber, said curing agent is selected from the group consisting of a sulfur and surfactant blend, an amine, an epoxide, and a combination thereof;
(iii) when said elastomer precursor gum is a precursor gum for ethylene acrylic rubber, said curing agent is selected from the group consisting of a peroxide, an amine, and a combination thereof;
(iv) when said elastomer precursor gum is a precursor gum for silicone, said curing agent is platinum;
(v) when said elastomer precursor gum is a precursor gum for nitrile butyl rubber, said curing agent is selected from the group consisting of a peroxide, sulfur, and a combination thereof;
(vi) when said elastomer precursor gum is a precursor gum for hydrogenated nitrile rubber, said curing agent is selected from the group consisting of a peroxide, sulfur, and a combination thereof;
(vii) when said elastomer precursor gum is a precursor gum for natural rubber, said curing agent is sulfur;
(viii) when said elastomer precursor gum is a precursor gum for polyurethane, said curing agent is selected from the group consisting of a peroxide, a glycol, an amine, a multi-functional alcohol having a plurality of reduction groups for reducing isocyanatyl groups, and a combination thereof; and
(ix) when said elastomer precursor gum is a precursor gum for styrene butadiene rubber, said curing agent is selected from the group consisting of sulfur, a peroxide, and a combination thereof.

74. The method of claim 54 wherein said admixing is achieved with any of batch polymer mixer, a roll mill, a continuous mixer, a single-screw mixing extruder, and a twin-screw extruder mixing extruder.

75. An admixture made by a process according to the method of claim 54.

76. An admixture made by a process according to the method of claim 60.

77. An admixture made by a process according to the method of claim 66.

78. An article made by a process according to the method of claim 70.
